(19) United States
(12) Patent Application Publication
(10) Pub. No.: US 2026/0136174 A1
(43) Pub. Date: May 14, 2026

(54) PRIVACY-PRESERVING STATION ROAMING

(71) Applicant: Cisco Technology, Inc., San Jose, CA (US)

(72) Inventors: Jerome Henry, Pittsboro, NC (US); Binita Gupta, San Diego, CA (US); Sudhir Kumar Jain, Fremont, CA (US); Brian Hart, Sunnyvale, CA (US)

(73) Assignee: Cisco Technology, Inc., San Jose, CA (US)

(21) Appl. No.: 19/383,355

(22) Filed: Nov. 7, 2025

Related U.S. Application Data
(60) Provisional application No. 63/718,598, filed on Nov. 9, 2024.

(51) Int. Cl. H04W 12/02; H04B 17/318; H04W 64/00

(52) U.S. Cl. CPC H04W 12/02; H04B 17/318; H04W 64/00

(57) ABSTRACT

Privacy-preserving roaming may be provided. Privacy-preserving roaming can include receiving, from a station (STA), a privacy-preserving neighbor report request comprising a privacy-preserving address instead of a Media Access Control (MAC) address. A privacy-preserving neighbor report is determined for the STA comprising a list of one or more recommended access points (APs) for the STA to connect to. The privacy-preserving neighbor report response comprising the privacy-preserving neighbor report is sent to the STA, wherein the STA is configured to connect to one of the one or more recommended APs based on the privacy-preserving neighbor report.

### RELATED APPLICATION

Under provisions of 35 U.S.C. § 119(e), Applicant claims the benefit of and priority to U.S. Provisional Application No. 63/718,598, filed November 9, 2024, the disclosure of which is incorporated herein by reference in its entirety.

### TECHNICAL FIELD

The present disclosure relates generally to providing privacy-preserving roaming.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for privacy-preserving roaming in accordance with aspects of the present disclosure.

FIG. 2 is a block diagram of the operating environment for privacy-preserving roaming for a moving Station (STA) in accordance with aspects of the present disclosure.

FIG. 3 is a flow chart of a method for privacy-preserving roaming in accordance with aspects of the present disclosure.

FIG. 4 is a block diagram of a computing device in accordance with aspects of the present disclosure.

FIG. 5 is a block diagram of a computing device in accordance with aspects of the present disclosure.

### DETAILED DESCRIPTION

### OVERVIEW

Privacy-preserving roaming may be provided. Privacy-preserving roaming can include receiving, from a station (STA), a privacy-preserving neighbor report request comprising a privacy-preserving address instead of a Media Access Control (MAC) address. A privacy-preserving neighbor report is determined for the STA comprising a list of one or more recommended access points (APs) for the STA to connect to. The privacy-preserving neighbor report response comprising the privacy-preserving neighbor report is sent to the STA, wherein the STA is configured to connect to one of the one or more recommended APs based on the privacy-preserving neighbor report.

Both the foregoing overview and the following example embodiments are examples and explanatory only and should not be considered to restrict the disclosure’s scope, as described, and claimed. Furthermore, features and/or variations may be provided in addition to those described. For example, embodiments of the disclosure may be directed to various feature combinations and sub-combinations described in the example embodiments.

### EXAMPLE EMBODIMENTS

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Roaming in Wi-Fi occurs when a station (STA) (e.g., a client device, user equipment, etc.) moves outside of the range of an Access Point (AP) and connects to a new AP the STA is in range of. In some instances, a STA will scan available channels when roaming to look for the best available AP to connect to. Scanning can introduce latency and otherwise disrupt connectivity, however. In other instances, a STA may perform zero-scan roaming, a wireless communication technique that enables a STA to transition between APs within a wireless network without performing an active or passive channel scan of all channels. During zero-scan roaming operation, a STA may only need to scan the channel of the target AP to roam to for validation.

Zero-scan roaming eliminates the need for scanning, but the STA’s connection can still be disrupted if the STA does not have accurate information on how to quickly identify the best candidate AP(s) to roam to. Roaming and other service set transition decisions (e.g., which AP to transfer the connection to) are typically made by the STA, but there are ways for the network and associated devices to assist the STA’s decision making. For example, the Institute of Electrical and Electronics Engineers (IEEE) 802.11k amendment describes a process to create and share a neighbor report containing information about known neighbor APs that are candidates for a service set transition. STAs can utilize the neighbor report so the STA does not need to perform a full scan across one or more entire radio bands to identify available APs and/or does not connect to an overutilized or otherwise congested AP simply because that AP has the strongest signal at the time the client determines to roam to a new AP. For example, a STA can determine to roam to an AP in a received neighbor report when certain transition conditions are met (e.g., signal degradation, load balancing triggers, or motion detection) without performing a scan operation. The STA may perform the scanning phase only for one or more of the APs included in the neighbor report in some embodiments.

By bypassing or reducing the scanning phase of roaming, zero-scan roaming reduces handoff latency, minimizes packet loss, and improves the user experience for latency-sensitive applications such as voice over Wi-Fi or real-time streaming. Zero-scan roaming also conserves client power and reduces overall channel congestion associated with frequent scanning operations. However, using neighbor reports can introduce other issues. Neighbor reports can be limited to the “loudest” (i.e., highest detected signal strength) neighbors around the current AP, from the current AP’s viewpoint. While the list enables a STA to limit scanning to a subset of channels (e.g., channels of the APs in the list), the list of channels to scan may still be long. Additionally, the STA may not be able to detect each AP in the neighbor report list. For example, a STA in one direction may detect a subset of the APs in the list in that direction, while a STA moving in another direction may detect a different subset of APs.

Existing zero-scan roaming services are generally designed for STAs that are already associated with, and therefore identifiable by, an AP or controller. However, in public environments (e.g., airports, venues, or other open-access Wi-Fi networks), a STA user may want to utilize zero-scan roaming functionality (e.g., to maintain a seamless video call or streaming session while moving throughout the venue) without disclosing position information (e.g., location information, movement information) or other identifying information to the network infrastructure. The user may have privacy concerns regarding the collection or storage of personally identifiable information (PII) or other usage data associated with their device activity. The user may also desire not to participate in on-channel exchanges with the infrastructure, such as for the infrastructure to locate the STA. Therefore, systems and processes (e.g., methods) are described herein for providing zero-scan-like service without requiring a STA to provide private information including PII-associated information (e.g., the STA’s Media Access Control (MAC) address).

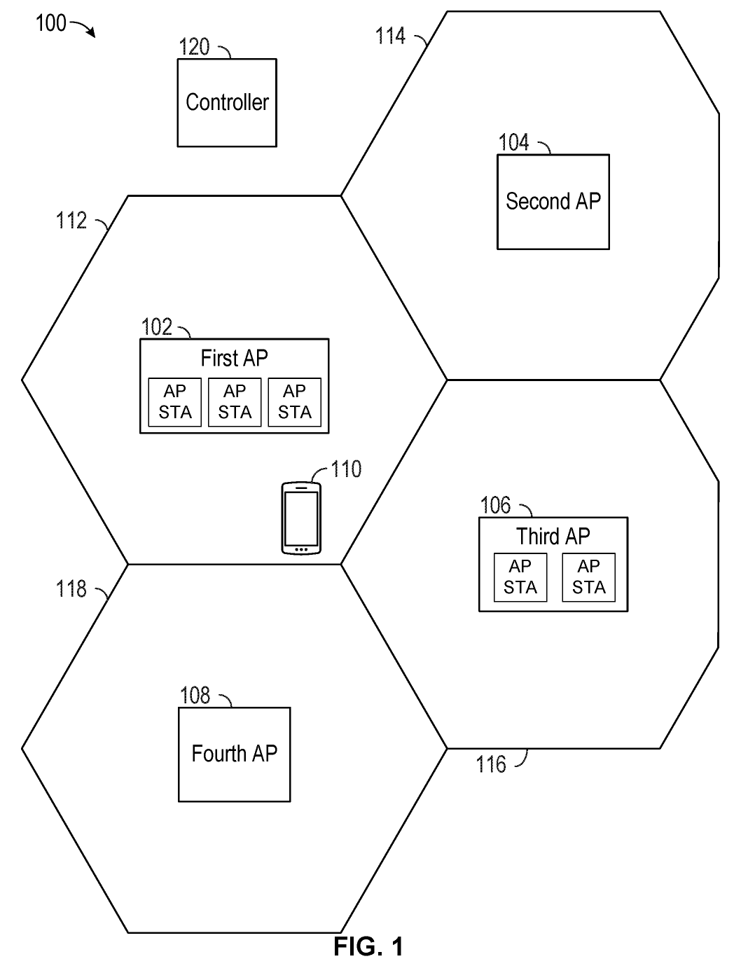

FIG. 1 is a block diagram of an operating environment 100 for providing privacy-preserving roaming. The operating environment 100 may include a first AP 102, a second AP 104, a third AP 106, a fourth AP 108, a STA 110, and a controller 120. The first AP 102 may have a service area or cell indicated by the first cell 112. Similarly, the second AP 104 has the second cell 114, the third AP 106 has the third cell 116, and the fourth AP 108 has the fourth cell 118. Therefore, the first AP 102, the second AP 104, the third AP 106, and the fourth AP 108 may be non-collocated and each correspond to a different cell. The range of the first AP 102, the second AP 104, the third AP 106, and the fourth AP 108 may extend past the boundary of the associated cells, but the signals of the APs grow weaker past the boundaries of the respective cells. Thus, the first AP 102, the second AP 104, the third AP 106, and the fourth AP 108 may fail to communicate with devices some distance past the edges of the associated cells. The edges of the first cell 112, the second cell 114, the third cell 116, and the fourth cell 118 as shown in the operating environment 100 are an example and may be different in other examples (e.g., different sizes, shapes, etc.).

The STA 110 may be any device that connects to the network to communicate with other devices on the network, such as a smart phone, a tablet, a personal computer, a server, and/or the like. The controller 120 may be any network controller (e.g., a WLAN controller) and may provision, control, and otherwise manage the first AP 102, the second AP 104, the third AP 106, the fourth AP 108, and/or other network devices to allow wireless devices such as the STA 110 to connect to the network. In some embodiments, the operations of the controller 120 described herein may be performed by one or more of the first AP 102, the second AP 104, the third AP 106, the fourth AP 108, and/or another device, and vice versa. The operating environment 100 is an example configuration and there may be a different number of STAs, APs, controllers, and/or other devices in further examples.

The first AP 102, the second AP 104, the third AP 106, and/or the fourth AP 108 may be Multi-Link Devices (MLDs) each including multiple AP STAs. For example, the first AP 102 is illustrated as having three AP STAs, and the third AP 106 is illustrated as having two AP STAs. However, each AP can have any number of AP STAs in further embodiments. Each AP STA may include Physical (PHY)-layer and lower-Media Access Control (MAC) components. The first AP 102, the second AP 104, the third AP 106, and the fourth AP 108 may also include an upper-MAC for coordinating the AP STAs and providing Logical Link Control (LLC).

Each AP STA may act as an AP and a single link of the respective MLD, and each AP STA of a respective AP may use a different channel. For example, the first AP 102 may include three AP STAs, with one AP STA operating on one of the channels of the 2.4 Gigahertz (GHz) band (e.g., channel one with center frequency 2.412 GHz, channel two with center frequency 2.417 GHz, channel three with center frequency 2.422 GHz, etc.), one AP STA operating on a channel of the 5 GHz band, and one AP STA operating on a channel of the 6 GHz band. The first AP 102, the second AP 104, the third AP 106, and the fourth AP 108 may be co-channel APs, with the respective AP STAs operating on one or more of the same channels. Clients, such as the STA 110, can link or connect to one or more AP STAs of the first AP 102, the second AP 104, the third AP 106, and the fourth AP 108.

The devices of the network, including the first AP 102, the second AP 104, the third AP 106, the fourth AP 108, and/or the controller 120 for example, can enable privacy-preserving zero-scan roaming by providing a privacy-preserving neighbor report including a list of next best APs to roam to or otherwise connect to. The privacy-preserving neighbor report can be generated without requiring the STA 110 to be associated to an AP nor provide private information (e.g., PII-associated information such as the MAC address of the STA 110) by using an estimated location of the STA 110, enabling the STA 110 to perform location determination processes itself, or the like as will be described in further detail herein. Therefore, the privacy-preserving neighbor report is adapted or otherwise optimized for the STA 110 (e.g., based on position information such as location and movement information) without requiring the devices to receive private information from the STA 110.

The APs can advertise capabilities for privacy-preserving zero-scan roaming to enable devices such as the STA 110 to utilize the privacy-preserving zero-scan roaming. The APs can advertise the capabilities via periodic broadcasting (e.g., Beacon frames), on-demand frames (e.g., probe responses), discovery frames, and so on in various embodiments. For example, the first AP 102, the second AP 104, the third AP 106, and the fourth AP 108 can advertise the support for privacy-preserving zero- scan roaming, and the client device can determine to request a privacy-preserving neighbor report to initiate privacy-preserving zero-scan roaming.

The STA 110 can send a privacy-preserving neighbor report request to an AP, such as an AP is currently communicating with or able to communicate with (e.g., when the STA 110 has not yet associated). In the illustrated embodiment for example, the STA 110 can send the request for the privacy-preserving neighbor report to the first AP 102 since the STA 110 is in the first cell 112 and within range of the first AP 102. The privacy-preserving neighbor report request can be a request as defined by the 802.11k amendment in example embodiments. The first AP 102 (or another AP the STA 110 can communicate with) responds to the request from the STA 110 with a privacy-preserving neighbor report. The STA 110 can then use the privacy-preserving neighbor report to determine which AP to roam to or otherwise connect to.

The STA 110 may transmit a privacy‑preserving neighbor report request to an AP while not associated with the AP by using a privacy‑preserving address, such as a Randomized and Changing MAC (RCM) address, as the Transmitter Address (TA) and/or the Source Address (SA) of the privacy-preserving neighbor report request. When unassociated, the STA 110 may utilize the privacy‑preserving neighbor report while moving throughout the operating environment to discover accessible APs without performing a full scan. In further embodiments, when the STA 110 is associated with an AP and uses a MAC address for ordinary communications, the STA 110 can still use a privacy-preserving address different from the utilized MAC address when sending the privacy-preserving neighbor report request. By decoupling the request from the MAC address used for association, the STA 110 can obtain a privacy-preserving neighbor report from the AP without disclosing private information, including PII and location information that could be inferred from the associated MAC address. Accordingly, the STA 110 can send a privacy‑preserving neighbor report request to an AP whether it is associated with that AP.

The privacy-preserving address can be unique identifier used in place of the STA’s MAC address, and the APs, the controller 120, and the like can utilize the privacy-preserving address as a unique identifier of the STA 110 once the privacy-preserving address is received. In certain embodiments, the receiving AP does not need to recognize the MAC address the STA 110 provides in the TA or SA and will generate and send the privacy-preserving neighbor report. The STA 110 can therefore perform privacy-preserving zero-scan roaming without being associated with an AP. In other embodiments, the receiving AP must recognize the MAC address the STA 110 provides in the TA or SA, so the STA 110 must have been associated with an AP at some time before sending the privacy-preserving neighbor report request. The APs may require recognizing the MAC address the STA 110 provides in the TA or SA to avoid attacks from rogue STAs. The STA 110 can include other information in the privacy-preserving neighbor report request so an AP will respond in example implementations, as will be described in further detail herein.

In some embodiments, the privacy-preserving neighbor report request can include a request for Location Configuration Information (LCI) of APs in the privacy-preserving neighbor report. LCI of a device can include the geographic coordinates, such as latitude, longitude, and altitude, of the respective device. In response to the request, the privacy-preserving neighbor report response includes the list of recommended APs and the LCI information of the recommended APs. The STA 110 may be able to determine its own location and movement and determine the next best AP to connect to based on its position information and the neighbor report response including the LCI information.

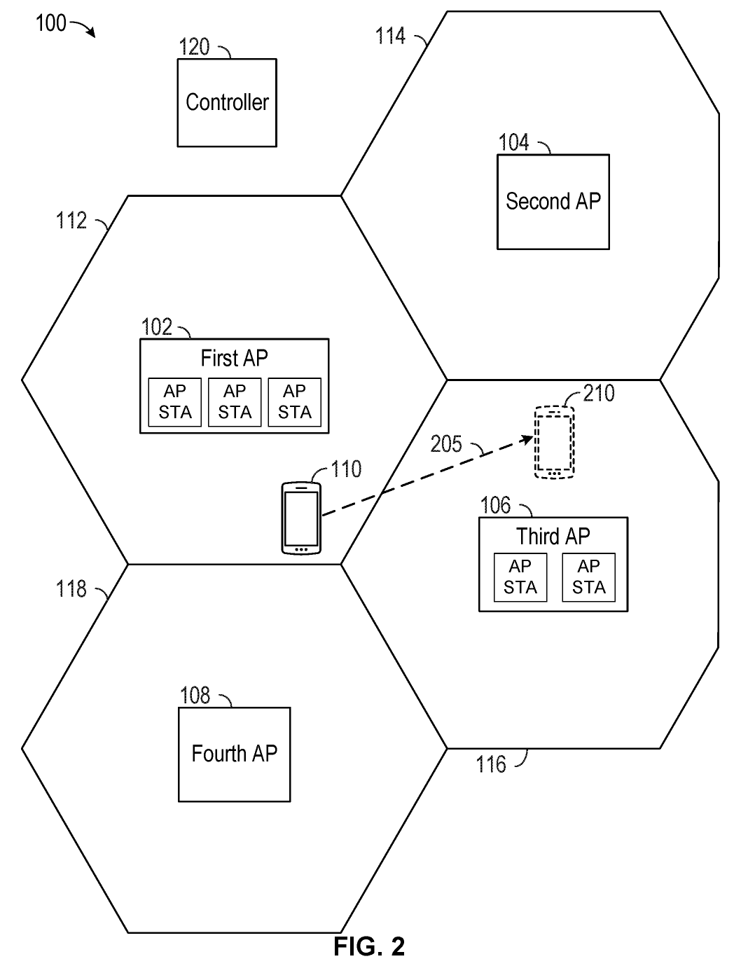

FIG. 2 illustrates the movement of the STA 110 in the operating environment 100. The STA 110 may have a current position in the first cell 112, a movement vector 205 (e.g., direction vector), and an expected position 210. The STA 110 can provide LCI or another location information element (IE) indicating its position information (e.g., location information and/or movement information) in certain embodiments (e.g., including the current position, the movement vector 205, the expected position 210, etc.). The receiving AP can then generate the privacy-preserving neighbor report based on the STA’s 110 LCI or other location IE. For example, the AP can evaluate APs to include in the privacy-preserving neighbor report based on the position, movement vector 205, expected position 210, to recommend APs that will be able to communicate with the STA 110 in the expected position 210 and during the movement of STA 110 as indicated by the movement vector 205 to the expected position 210. In the illustrated embodiment, the first AP 102 may determine the LCI and/or other location IE indicates that the third AP 106 and the second AP 104 are the best candidates for the STA 110 to roam to even though the STA 110 has a current position in the first cell 112 closest to the fourth AP 108 and the fourth cell 118. Because the STA 110 position information indicates the STA 110 will move away from the fourth AP 108, the first AP 102 may not include the fourth AP 108 in the privacy-preserving neighbor report. In some embodiments, the STA 110 may only provide current position information, and the first AP 102 may include the fourth AP 108 as a recommended AP in the privacy-preserving neighbor report. Thus, the STA 110 can provide position information, and the receiving AP can generate a privacy-preserving neighbor report based on the position information. When the privacy-preserving neighbor report request includes LCI or another location IE, the receiving AP may respond to the requesting STA without needing to recognize the provided MAC address or otherwise requiring the STA to identify itself.

In certain embodiments, the STA 110 sends the LCI information, direction vector, and any other position information of the STA 110 to the associated AP in a Basic Service Set (BSS) Transition Management (BTM) Query frame. The LCI information of the recommended APs in the privacy-preserving neighbor report can be included in the BTM Request frame the AP sends to the STA 110 to enable the STA 110 to determine the best APs to roam to, based on the location and movement of the STA 110. In some embodiments, the STA 110 can send the LCI information, direction vector, and any other position information of the STA 110 in any roaming preparation request in a seamless roaming or seamless mobile domain (SMD) roaming procedure. For example, the STA 110 may be requesting to prepare/pre-setup links with multiple target AP MLDs for roaming in the near future.

The STA 110 may include multiple radios, several of which have location or ranging capabilities (e.g., Ultra-Wideband (UWB), Bluetooth Low Energy (BLE), Wi-Fi). However, the STA 110 may not be able determine its own location (e.g., because the device does not have a venue map). Furthermore, some technologies like UWB are unidirectional, so the technology for navigation is not the same as the technology for asset tracking. The STA 110, for example, can measure its distance to UWB anchors using UWB but is unable to send its location over UWB. Therefore, the position information the STA 110 sends comprises raw ranging information in certain embodiments. The STA 110 can format the raw ranging information according to the Fine Ranging (FiRa) format, with IEs that include and an anchor ID, a BLE universally unique ID (UUID), range/signal level elements, and/or the like. The APs, the controller 120, and/or other network devices can use the raw ranging information to determine the position and/or the movement of the STA 110 for generating the privacy-preserving neighbor report.

In some embodiments, the STA 110 sends the raw ranging data to the associated AP in a BTM Query frame. The network devices can use this information to compute the position and/or movement of the STA 110, generate the privacy-preserving neighbor report based on the position and/or movement of the STA 110, and send the privacy-preserving neighbor report in the BTM Request frame to the STA 110. The information sent by the STA 110 can also include raw ranging data from other technologies for the AP to better determine the STA's 110 location. In that case, the serving AP can use the LCI, direction vector, raw ranging data, and so on of the STA 110 to prepare the most optimal AP(s) for the privacy-preserving neighbor report, including APs that were not requested by the STA 110 but are optimal APs for roaming. The AP can provide the privacy-preserving neighbor report in the roaming preparation response to the STA 110.

In certain embodiments, the STA 110 and an AP use a rendezvous channel for location and movement tracking, such as for reporting Received Signal Strength Indicator (RSSI) measurements. APs can indicate the rendezvous channel via a rendezvous channel IE, field, or subfield when advertising capabilities for privacy-preserving zero-scan roaming. For example, the rendezvous channel IE, field, or subfield can be included in Beacons, Probe Responses, and so on. The rendezvous channel IE, field, or subfield can include a channel number and optional parameters (e.g., availability time window).

The STA 110 can switch to or otherwise utilize the rendezvous channel at the availability period advertised by the AP. For example, the availability period may be a period where monitor and scan radios of neighboring APs tune to the rendezvous channel. The STA 110 can send a frame (e.g., a probe, a request to send (RTS) frame) including position information such as raw location information using a privacy-preserving address (e.g., the STA’s intended RCM address). The network devices (e.g., the APs, the controller 120, etc.) can use the frame to compute the STA’s 110 approximate location and movement (and/or Uplink (UL) RSSI). The AP can then use the position information to determine which APs to include in the privacy-preserving neighbor report. The AP can also share the UL RSSI measured for the STA 110 on the rendezvous channel as part of the privacy-preserving neighbor report response or a BTM Request sent to the STA 110. Using the primary AP channel, the STA 110 can send the privacy-preserving neighbor report request, for example using the same MAC as the one used for the STA 110 message on the rendezvous channel. The AP returns the privacy-preserving neighbor report matching the respective MAC address. In any embodiment described above, the STA 110 can obtain a privacy-preserving neighbor report, enabling zero-scan roaming services, without having to disclose its MAC address and other PII-associated information.

In some embodiments, the AP that measured STA’s 110 position information can provide the privacy-preserving neighbor report to the STA 110 without waiting to receive a privacy-preserving neighbor report request from the STA 110. For example, the APs can coordinate to determine position information, and an AP can send a BTM Request to provide the privacy-preserving neighbor report to the STA 110. The APs can correlate the STA’s 110 privacy-preserving address (e.g., RCM address) used on the rendezvous channel with the STA’s 110 current associated AP and send the BTM Request via the currently associated AP.

In certain embodiments, an AP may provide LCI information for recommended neighboring APs in the privacy-preserving neighbor report for roaming in a pre-roaming step for seamless or SMD roaming. For example, the LCI of the APs may be provided in an existing or new frame providing the privacy-preserving neighbor report for seamless roaming. The STA 110 can use the LCI information of the APs to determine the next best AP (e.g., based on the STA 110 measuring its own location and computing its own movement). In some embodiments, when providing a privacy-preserving neighbor report for seamless roaming in a management or action frame, the network devices can also include an RSSI threshold for the BSS Service Area (BSA) mid-point for each AP in the privacy-preserving neighbor report. The STA 110 can use the RSSI threshold to determine when to start looking for roaming candidates for performing seamless roaming.

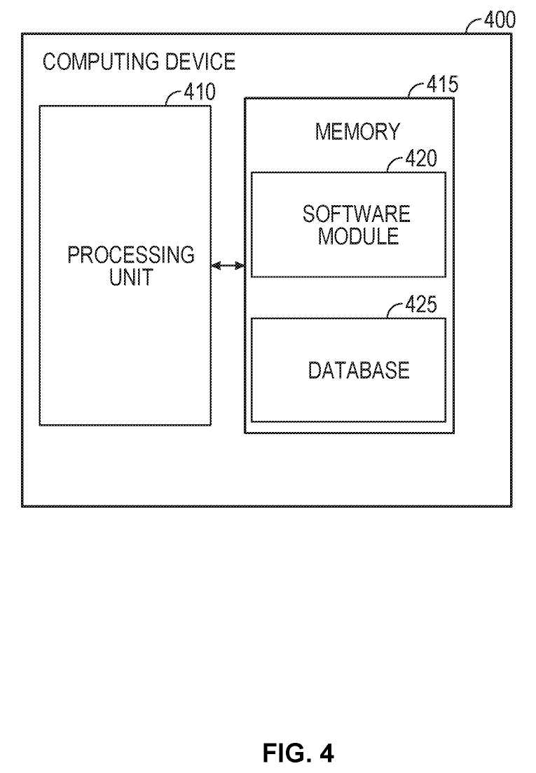

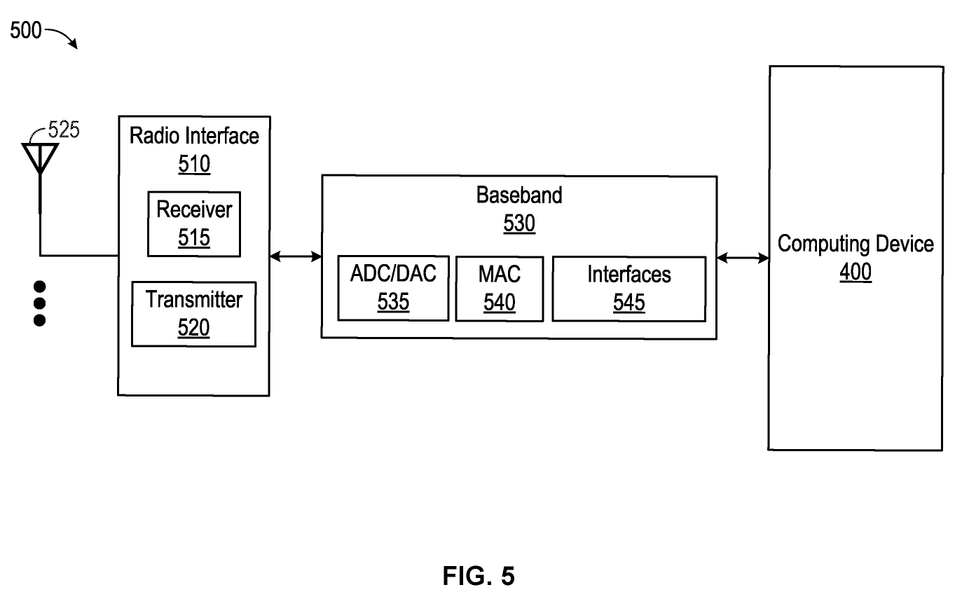

The elements described above of the operating environment 100 (e.g., the first AP 102, the second AP 104, the third AP 106, the fourth AP 108, the STA 110, the controller 120, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 4 and 5, the elements of the operating environment 100 may be practiced in a computing device 400 and/or communications device 500.

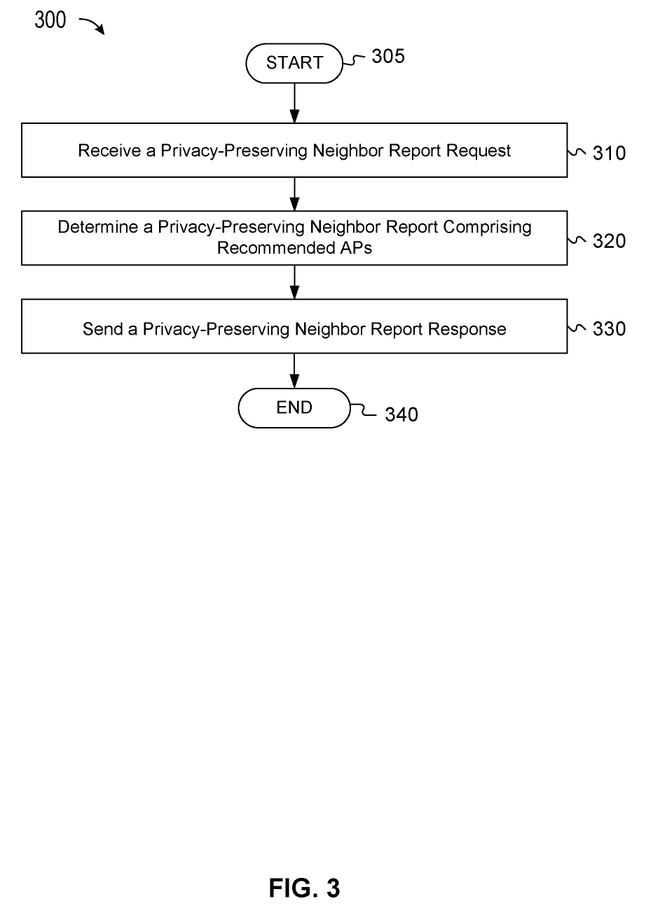

FIG. 3 is a flow chart of a method 300 for privacy-preserving roaming. The method 300 begins at starting block 305 and proceeds to operation 310. In operation 310, a privacy-preserving neighbor report request is received. For example, an AP receives the privacy-preserving neighbor report request from the STA 110. The privacy-preserving neighbor report request may comprise a privacy-preserving address instead of a MAC address. The privacy-preserving address is an RCM address in example implementations.

In operation 320, a privacy-preserving neighbor report is determined comprising one or more recommended APs. For example, the AP determines a privacy-preserving neighbor report including the list of recommended APs based on processes described above and/or in the 802.11k amendment.

In operation 330, a privacy-preserving neighbor report response is sent to the STA. For example, the AP sends the privacy-preserving neighbor report response comprising the privacy-preserving neighbor report to the STA 110. In some embodiments, the STA 110 is unassociated or otherwise not connected to any AP.

In some embodiments, the privacy-preserving neighbor report request further comprises position information of the STA 110 such as LCI of the STA 110, a location IE, a location of the STA 110, a movement vector of the STA 110, raw ranging information, and/or RSSI measurements. The AP can determine the privacy-preserving neighbor report based on the position information.

In certain embodiments, the privacy-preserving neighbor report request further comprises a request for LCI of the one or more recommended APs, determining the privacy-preserving neighbor report comprises determining the LCI of the one or more recommended APs, and the privacy-preserving neighbor report includes the LCI of the one or more recommended APs. The method 300 can further include receiving, from the STA 110, position information of the STA 110 via a rendezvous channel, wherein determining the privacy-preserving neighbor report is based on the position information. In some embodiments, the privacy-preserving neighbor report request comprises a BTM Query frame, and the privacy-preserving neighbor report response comprises a BTM Request frame. The method 300 can conclude at ending block 340.

FIG. 4 is a block diagram of a computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for privacy-preserving zero-scan roaming with respect to FIG. 1 and FIG. 2. Computing device 400, for example, may provide an operating environment for the first AP 102, the second AP 104, the third AP 106, the fourth AP 108, the STA 110, the controller 120, and the like. The first AP 102, the second AP 104, the third AP 106, the fourth AP 108, the STA 110, the controller 120, and the like may operate in other environments and are not limited to computing device 400.

Computing device 400 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples, and computing device 400 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods’ stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the elements illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure may be performed via application-specific logic integrated with other components of computing device 400 on the single integrated circuit (chip).

FIG. 5 illustrates an implementation of a communications device 500 that may implement one or more of the first AP 102, the second AP 104, the third AP 106, the fourth AP 108, the STA 110, the controller 120, etc., of FIGS. 1-2. In various implementations, the communications device 500 may comprise a logic circuit. The logic circuit may include physical circuits to perform operations described for one or more of the first AP 102, the second AP 104, the third AP 106, the fourth AP 108, the STA 110, the controller 120, etc., of FIGS. 1-2, for example. As shown in FIG. 5, the communications device 500 may include one or more of, but is not limited to, a radio interface 510, baseband circuitry 530, and/or the computing device 400.

The communications device 500 may implement some or all of the structures and/or operations for the first AP 102, the second AP 104, the third AP 106, the fourth AP 108, the STA 110, the controller 120, etc., of FIGS. 1-2, storage medium, and logic circuit in a single computing entity, such as entirely within a single device. Alternatively, the communications device 500 may distribute portions of the structure and/or operations using a distributed system architecture, such as a client station server architecture, a peer-to-peer architecture, a master-slave architecture, etc.

A radio interface 510, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 510 may include, for example, a receiver 515 and/or a transmitter 520. The radio interface 510 may include bias controls, a crystal oscillator, and/or one or more antennas 525. In additional or alternative configurations, the radio interface 510 may use oscillators and/or one or more filters, as desired.

The baseband circuitry 530 may communicate with the radio interface 510 to process, receive, and/or transmit signals and may include, for example, an Analog-To-Digital Converter (ADC) for down converting received signals with a Digital-To-Analog Converter (DAC) 535 for up converting signals for transmission. Further, the baseband circuitry 530 may include a baseband or PHYsical layer (PHY) processing circuit for the PHY link layer processing of respective receive/transmit signals. Baseband circuitry 530 may include, for example, a MAC processing circuit 540 for MAC/data link layer processing. Baseband circuitry 530 may include a memory controller for communicating with MAC processing circuit 540 and/or a computing device 400, for example, via one or more interfaces 545.

In some configurations, PHY processing circuit may include a frame construction and/or detection module, in combination with additional circuitry such as a buffer memory, to construct and/or deconstruct communication frames. Alternatively or in addition, MAC processing circuit 540 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure’s scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

1. A method comprising:
receiving, from a station (STA), a privacy-preserving neighbor report request comprising a privacy-preserving address instead of a Media Access Control (MAC) address;
determining a privacy-preserving neighbor report for the STA comprising a list of one or more recommended access points (APs) for the STA to connect to; and
sending, to the STA, a privacy-preserving neighbor report response comprising the privacy-preserving neighbor report, wherein the STA is configured to connect to one of the one or more recommended APs based on the privacy-preserving neighbor report.

2. The method of claim 1, wherein the STA is unassociated.

3. The method of claim 1, wherein the privacy-preserving address is a randomized and changing MAC (RCM) address.

4. The method of claim 1, wherein:
the privacy-preserving neighbor report request further comprises position information of the STA, wherein the position information comprises any one of (i) location configuration information (LCI) of the STA, (ii) a location information element, (iii) a location of the STA, (iv) a movement vector of the STA, (v) raw ranging information, (vi) received signal strength indicator (RSSI) measurements, or (vii) any combination of (i)-(vi); and
determining the privacy-preserving neighbor report is based on the position information.

5. The method of claim 1, wherein:
the privacy-preserving neighbor report request further comprises a request for LCI of the one or more recommended APs;
determining the privacy-preserving neighbor report comprises determining the LCI of the one or more recommended APs; and
the privacy-preserving neighbor report includes the LCI of the one or more recommended APs.

6. The method of claim 1, further comprising:
receiving, from the STA, position information of the STA via a rendezvous channel, wherein the position information comprises any one of (i) location configuration information (LCI) of the STA, (ii) a location information element, (iii) a location of the STA, (iv) a movement vector of the STA, (v) raw ranging information, (vi), received signal strength indicator (RSSI) measurements, or (vii) any combination of (i)-(vi); and
wherein determining the privacy-preserving neighbor report is based on the position information.

7. The method of claim 1, wherein:
the privacy-preserving neighbor report request comprises a Basic Service Set (BSS) Transition Management (BTM) Query frame; and
the privacy-preserving neighbor report response comprises a BTM Request frame.

8. A system comprising:
a memory storage; and
a processing unit coupled to the memory storage, wherein the processing unit is operative to:
receive, from a station (STA), a privacy-preserving neighbor report request comprising a privacy-preserving address instead of a Media Access Control (MAC) address;
determine a privacy-preserving neighbor report for the STA comprising a list of one or more recommended access points (APs) for the STA to connect to; and
send, to the STA, a privacy-preserving neighbor report response comprising the privacy-preserving neighbor report, wherein the STA is configured to connect to one of the one or more recommended APs based on the privacy-preserving neighbor report.

9. The system of claim 8, wherein the STA is unassociated.

10. The system of claim 8, wherein the privacy-preserving address is a randomized and changing MAC (RCM) address.

11. The system of claim 8, wherein:
the privacy-preserving neighbor report request further comprises position information of the STA, wherein the position information comprises any one of (i) location configuration information (LCI) of the STA, (ii) a location information element, (iii) a location of the STA, (iv) a movement vector of the STA, (v) raw ranging information, (vi) received signal strength indicator (RSSI) measurements, or (vii) any combination of (i)-(vi); and
determining the privacy-preserving neighbor report is based on the position information.

12. The system of claim 8, wherein:
the privacy-preserving neighbor report request further comprises a request for LCI of the one or more recommended APs;
determining the privacy-preserving neighbor report comprises determining the LCI of the one or more recommended APs; and
the privacy-preserving neighbor report includes the LCI of the one or more recommended APs.

13. The system of claim 8, the processing unit being further operative to:
receive, from the STA, position information of the STA via a rendezvous channel, wherein the position information comprises any one of (i) location configuration information (LCI) of the STA, (ii) a location information element, (iii) a location of the STA, (iv) a movement vector of the STA, (v) raw ranging information, (vi), received signal strength indicator (RSSI) measurements, or (vii) any combination of (i)-(vi); and
wherein determining the privacy-preserving neighbor report is based on the position information.

14. The system of claim 8, wherein:
the privacy-preserving neighbor report request comprises a Basic Service Set (BSS) Transition Management (BTM) Query frame; and
the privacy-preserving neighbor report response comprises a BTM Request frame.

15. A non-transitory computer-readable medium that stores a set of instructions which when executed perform a method executed by the set of instructions comprising:
receiving, from a station (STA), a privacy-preserving neighbor report request comprising a privacy-preserving address instead of a Media Access Control (MAC) address;
determining a privacy-preserving neighbor report for the STA comprising a list of one or more recommended access points (APs) for the STA to connect to; and
sending, to the STA, a privacy-preserving neighbor report response comprising the privacy-preserving neighbor report, wherein the STA is configured to connect to one of the one or more recommended APs based on the privacy-preserving neighbor report.

16. The non-transitory computer-readable medium of claim 15, wherein the STA is unassociated.

17. The non-transitory computer-readable medium of claim 15, wherein the privacy-preserving address is a randomized and changing MAC (RCM) address.

18. The non-transitory computer-readable medium of claim 15, wherein:
the privacy-preserving neighbor report request further comprises position information of the STA, wherein the position information comprises any one of (i) location configuration information (LCI) of the STA, (ii) a location information element, (iii) a location of the STA, (iv) a movement vector of the STA, (v) raw ranging information, (vi) received signal strength indicator (RSSI) measurements, or (vii) any combination of (i)-(vi); and
determining the privacy-preserving neighbor report is based on the position information.

19. The non-transitory computer-readable medium of claim 15, wherein:
the privacy-preserving neighbor report request further comprises a request for LCI of the one or more recommended APs;
determining the privacy-preserving neighbor report comprises determining the LCI of the one or more recommended APs; and
the privacy-preserving neighbor report includes the LCI of the one or more recommended APs.

20. The non-transitory computer-readable medium of claim 15, the method executed by the set of instructions further comprising:
receiving, from the STA, position information of the STA via a rendezvous channel, wherein the position information comprises any one of (i) location configuration information (LCI) of the STA, (ii) a location information element, (iii) a location of the STA, (iv) a movement vector of the STA, (v) raw ranging information, (vi), received signal strength indicator (RSSI) measurements, or (vii) any combination of (i)-(vi); and
wherein determining the privacy-preserving neighbor report is based on the position information.
